(19) United States
(12) Patent Application Publication
(10) Pub. No.: US 2008/0120914 A1
(43) Pub. Date: May 29, 2008

(54) Pre-Hung Exterior Door Assembly and Sill Therefor

(75) Inventors: Klaus M. Fink, Maumee, OH (US); John E. Nemazi, Bloomfield Hills, MI (US)

Correspondence Address: CALFEE HALTER & GRISWOLD, LLP, 800 SUPERIOR AVENUE, SUITE 1400, CLEVELAND, OH, 44114, US

(73) Assignee: TT TECHNOLOGIES, INC., Edgerton, OH (US)

(21) Appl. No.: 11/534,413

(22) Filed: Sep. 22, 2006

(51) Int. Cl. E06B 1/70; E06B 7/16

(52) U.S. Cl. 49/469; 49/475.1

(57) ABSTRACT

A pre-hung door assembly and a door sill are provided in which the sill is affixed to the bottom surface thereof; an elongate elastomeric extending the length of the sill having a self-adhesive bottom surface adapted to sealingly bond to the bottom plate of a building rough opening. A removable release layer is attached to the elastomeric seal bottom surface to facilitate shipping and handling. The film is removable by an installer at the time of final installation of the door to achieve a weather tight seal

### BACKGROUND OF THE INVENTION

1. Field of the Invention

This invention relates to pre-hung entryway doors, door sills and the seal art used to bond the door sill to the rough building opening.

2. Background Art

When installing a pre-hung entryway door or a door sill into the rough opening in a building, typically the installer applies a heavy bead of sealant, caulk or construction adhesive on the bottom plate forming the lower portion of the building opening prior to the final installation of the pre-hung door assembly or the door sill. If the installer forgets to apply the sealant or if there are gaps in the sealant spanning between the door jambs, water can leak under the sill assembly into the building interior.

### SUMMARY OF THE INVENTION

One of the objectives of the present invention is to provide a reliable weather proof seal between the underside of the door sill and the rough entryway opening of the building. The invention is suitable for use with a sill assembly as well as a pre-hung exterior door assembly which includes a sill. The pre-hung exterior door assembly of the present invention is adapted for installation in a rough opening in a building, having a top rail, a pair of spaced apart generally vertical sides and a generally flat bottom plate. The pre-hung exterior door assembly has a generally U-shaped frame formed by a pair of vertical jambs and a top jamb spanning between the jamb upper ends. A sill assembly horizontally spans between the jamb lower ends and provides a horizontal upper threshold portion and a generally horizontal lower surface. The frame and sill collectively define a door opening in which an entryway door is mounted. An elongate elastomeric member is provided which extends the length of the sill and has an upper surface bonded to the sill lower surface and a self-adhesive bottom surface for attachment to the bottom plate forming the rough building opening. The self-adhesive bottom surface is protected by a removable release film layer which is removably attached to the elastomeric seal bottom surface to facilitate shipping and handling an initial fit up of the door assembly. Release film is removable by the installer at the time of final installation of the door in order to achieve a weather tight continuous seal between the sill and the building opening bottom plate spanning the entire length of the sill.

The present invention can alternatively be provided in the form of a sill assembly which is not integrated into a pre-hung exterior door. Prefabricated sill assemblies can be used to create a pre-hung door assembly at a door shop or alternatively, to form a door frame opening at the building construction site.

The elastomeric seal can be formed of a number of different materials including a layer of butyl rubber based sheet material, a polymer gel or a two sided self-adhesive foam tape. Preferably, the elastomeric seal member has a thickness between 0.050 and 0.25 inches in order to accommodate variations in the surface of the bottom plate and to accommodate a slight misalignment. In one embodiment of the invention, the elastomeric seal member is formed of a layer of sheet like material having a width greater than 1.0 inch and preferably greater than 2.0 inches to provide a wide contact layer between the underside of the sill and the rough opening bottom plate.

In another pre-hung exterior door assembly embodiment of the invention, the elastomeric seal can have a sufficient length to overlap the ends of the door jambs.

### BRIEF DESCRIPTION OF THE DRAWINGS

FIG. 1 illustrates a pre-hung entryway door assembly of the present invention;

FIG. 2 is an enlarged partial cross-sectional view of the entryway door of FIG. 1 and adjacent a building structure;

FIG. 3 is a cross-sectional plan view taken along section 3.3. in FIG. 1 further including an associated structure defining the building opening;

FIG. 4 is an enlarged exploded perspective view of the lower end of a door jamb in the associated brick mold;

FIG. 5 is a front elevational view of the intersection of a sill and door jamb;

FIG. 6 is an enlarged cross-sectional side elevation of a sill installed in a building opening;

FIG. 7 is a cross-sectional view of a sill based block and the associated elongate elastomeric seal member;

FIG. 8 is an alternative sill based block an and elongate elastomeric seal member;

FIG. 9 is yet another alternative sill based block and elongate elastomeric seal member;

FIG. 10 is a bottom plan view of the underside of a corner of a pre-hung entryway door assembly illustrating an elongate elastomeric seal member extending over the end of the door jamb;

FIG. 11 illustrates an alternative to the elastomeric seal member of FIG. 10 having separate elastomeric seal members covering the vertical jamb and brick mold end;

FIG. 12 illustrates a pre-hung entryway door assembly which includes a pair of skylights and a continuous sill of the present invention;

FIG. 13 illustrates a pre-hung entryway double-door assembly with a continuous sill of the present invention;

FIG. 14 illustrates a pre-hung entryway patio door of the present invention;

FIG. 15 illustrates an alternative release film embodiment; and

FIG. 16 illustrates a pre-hung entryway patio door provided with the release film embodiment illustrated in FIG. 15.

### DETAILED DESCRIPTION OF THE PREFERRED EMBODIMENT(S)

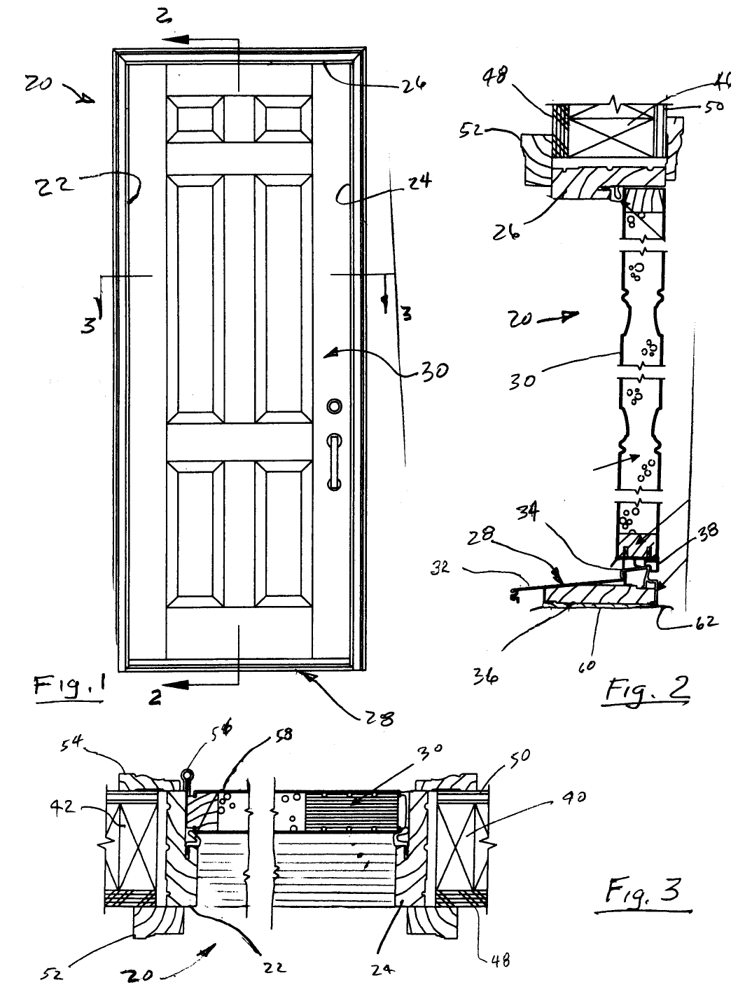

A pre-hung entryway door assembly 20 of the present invention is shown in FIGS. 1-3. The pre-hung entryway door is adapted to be installed within a rough opening of a building, the opening having a top, a pair of spaced apart generally vertical sides and a generally flat bottom plate. The building openings will vary in design based upon door shape and the type of building construction. In the illustrations of FIGS. 2 and 3, a stud construction building is illustrated, however, the invention is suitable for use in a wide variety of building constructions including masonry or steel frame buildings.

The pre-hung exterior door assembly 20 includes a door frame which is typically an inverted U-shape formed by a pair of vertical elongate jamb members 22 , 24 and a top jamb 26 spanning between and interconnecting the upper ends of the vertical jamb members. A sill assembly 28 horizontally spans between and interconnects the lower ends of the vertical jamb members 22 and 24. The sill 28 and the frame made up of vertical jambs 22 and 24 and top jamb 26 collectively define a doorway opening sized to receive an entryway door 30.

Sill assembly 28 illustrated in FIG. 2, is made up of an upper member 32 which is preferably of aluminum extrusion, a threshold portion 34 forming a raised rib immediately below the foremost edge of door 30 when the door is closed, and a sill block 36. A door bottom seal 38 on the bottom edge of door 30 provides a weather tight seal between the door and the threshold 34. Sill assembly 28 further includes a sill block 36 which historically were formed of wood, but, is preferably formed of a rot resistance composite material such as a plastic wood fiber blend. Sill block 36 is mounted upon a bottom plate of the rough building opening defining the entryway. The rough building opening will have a bottom plate and have a generally U-shaped frame opening which in the stud construction illustrated in FIG. 2 and FIG. 3, comprises a pair of vertical studs 40 and 42 and a top rail 46. The outside of the building is provided with exterior sheeting 48 and the inside provided with drywall 50.

The pre-hung entryway door 20 will typically be provided with a brick mold 52 affixed to the exterior side of the door frame attached to vertical jambs 22 and 24 and top jamb 26. When the entryway door 20 is installed into the rough opening from the building exterior, brick mold 52 abuts the building facing 48 as illustrated in FIGS. 2 and 3. Once the pre-hung exterior door has been installed in the rough building opening, a trim molding 54 is installed about the interior side of the door frame spanning any gaps between the door frame and the interior drywall. Typically during the installation process, shims or wedges will be installed between the studs defining the rough opening. The door frame will be nailed or screwed in place, once the pre-hung entryway door assembly is properly positioned and the door operates properly. Door 30 is pivotally connected to vertical jamb member 22 by a series of hinges 56 allowing the door 30 to pivotally open into the building interior. The flexible elastomeric seal 58 is mounted in a kerf cut in the door frame to sealingly cooperate with the periphery of door 30 when the door is closed to provide a weather tight seal.

Typically, a pre-hung entryway door is mounted to the bottom plate defining the lower most region of the rough door opening by construction adhesive between the bottom plate and the sill block. In the present invention, an elongate elastomeric seal member 60 extends the length of the underside of the sill and is bonded to the lower surface of the sill block 36. The elastomeric seal member 60 has a self-adhesive lower surface which bonds to the rough opening bottom plate. In order to facilitate handling of the pre-hung door assembly, a removable release film 62 is attached to the elastomeric seal 60 lower surface. The release film 62 enables the pre-hung door assembly 20 to be shipped, handled and initially fit up into the door opening prior to removal of the release film by the installer at the time of final installation of the door. The elastomeric seal member 60 provides a weather tight seal between the sill and the building opening bottom plate and is continuous along the sill's entire length.

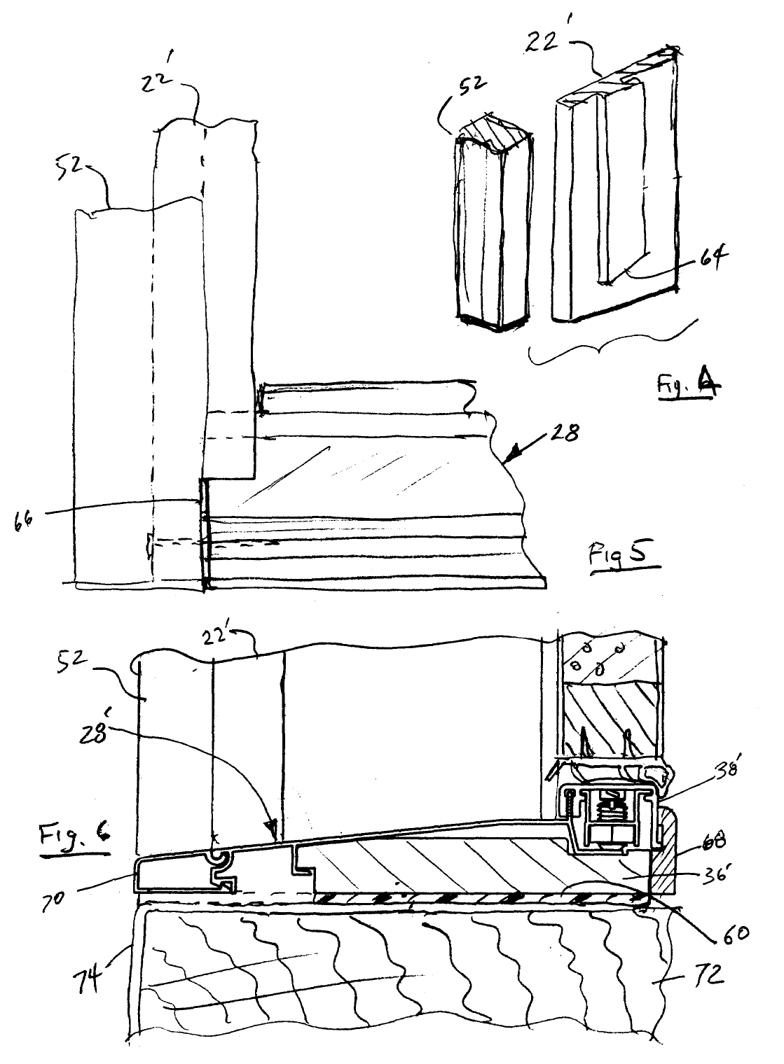

The sill assembly spans between the two vertical door jamb lower ends which are milled to cooperate with the sill. The lowermost end of a left vertical jamb member 22 is illustrated in FIG. 4 in exploded view along with the lowermost portion of a corresponding brick mold member 52. The lowermost portion of the jamb stop is cutout at an angle 64 corresponding to the slope of the sill. FIG. 5 illustrates an enlarged front view of the lower left corner of a pre-hung exterior door frame and sill assembly. Typically, screws will be run horizontally through the jamb into the sill block as shown in phantom in order to affix the sill assembly to the frame in the pre-hung door assembly. In order to provide a watertight seal, preferably sill end gasket 66 will be interposed between the end of the sill and the corresponding surface of the vertical jamb member 22.

FIG. 6 illustrates a cross-sectional side elevation of an installed entryway door having a sill assembly of the present invention. In this embodiment, sill assembly 28′ is provided with an adjustable threshold 38′, a sill block 36′ and trim molding 68. Vertical jamb 22′ is a wide type jamb and sill 28′ is provided with a sill extender 70. The sill assembly sits atop bottom plate 72 which is covered by a waterproof flashing 74. Flashing material varies dramatically depending on the type of construction and geographic region. Flashing may be formed of tar-like paper, vinyl siding, a thin layer of aluminum siding or in some geographic regions, a thin layer of lead sheet.

Sill assembly 28′ mounts atop flashing 74 as shown in the FIG. 6. embodiment. An elongate elastomeric seal member 60 is mounted to the bottom of sill block 36. When the door is installed the release film has been removed and is not visible. The elongate elastomeric seal member 60 is bonded to bottom plate 70 directly or indirectly through flashing 74. In the embodiment illustrated, the elastomeric seal member 60 has a fore and aft width corresponding to that of the sill plate. Alternatively, the elastomeric seal network can be narrower or alternatively, the elastomeric seal plate can extend forward to the forward edge of the sill upper member or alternatively, all the way to the front edge of the sill extender 70 as shown in a dotted outline in FIG. 6. Elastomeric seal member 60 can be made up of a wide variety of materials such as butyl rubber, a butyl/bitumen composition, a non-woven fiber mat impregnated with bitumen material, a variety of gels such as silicone gel or urethane gel or foamed pressure sensitive tapes. Various seal materials are illustrated in U.S. Pat. Nos. 5,981,010; 6,169,138; 6,737,369; 6,875,496 or 7,101,598, all of which are incorporated by reference herein for the purpose of disclosing suitable sealants.

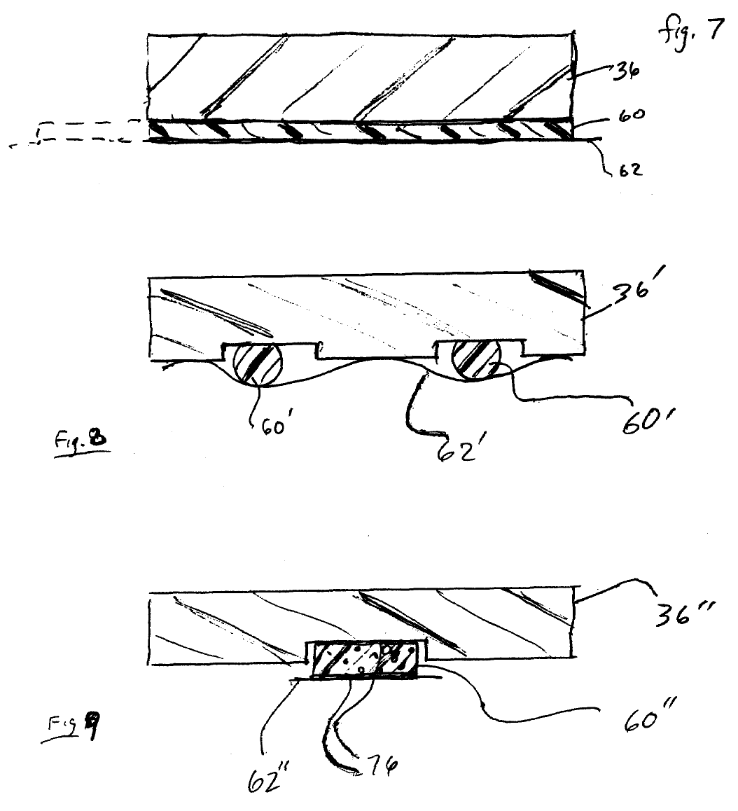

FIG. 7 illustrates a sill block 36 having a generally, planar horizontal lower surface to which is applied elastomeric seal member 60 and a release film 62. The elastomeric seal member 60 extends the entire width of the sill block 36 or it can alternatively extend forward of the sill block if desired as shown in phantom outline.

FIGS. 8 and 9 illustrate alternative constructions of sill blocks and the associated elastomeric seal members. In FIG. 8, sill block 36′ is provided with a generally flat horizontal lower bottom surface having a pair of longitudinally extended shallow channels formed therein. Elastomeric seal material 60′ forms two elongate beads positioned within the elongate channels and projecting substantially above the horizontal bottom surface of the sill block 36′. A release film layer 62′ covers the two pieces of seal member 60′. Sill block 36″ of FIG. 9 illustrates an alternative construction. A shallow channel is formed in the bottom of sill block 36″ sized to receive an elastomeric seal formed of two-sided adhesive foam tape 60″. Foam tape is a thickness substantially greater than the channel depths so that the tape stands proud of the sill bottom surface. Once again, adhesive film 62″ is mounted on the bottom surface of foam tape 60″. The top and bottom surfaces of the foam tape are covered with adhesive 76.

The elongate elastomeric seal member should have a substantial thickness so that it can accommodate irregularities in the building opening bottom plate as well as accommodating slight misalignments therebetween. When installed, the elastomeric seal member should have a fore and aft with at least one inch and preferably at least two inches. Most preferably, the elastomeric seal will span the entire fore and aft width of the bottom surface of the sill block. The thickness of the elastomeric seal is preferably about 0.050 to 0.250 inches and most preferably about 0.10 to 0.20 inches. When the elastomeric seal is oriented within a shallow channel in the sill block, elastomeric seal prior to installation should stand proud of the bottom surface of the sill block by 0.10 to 0.20 inches.

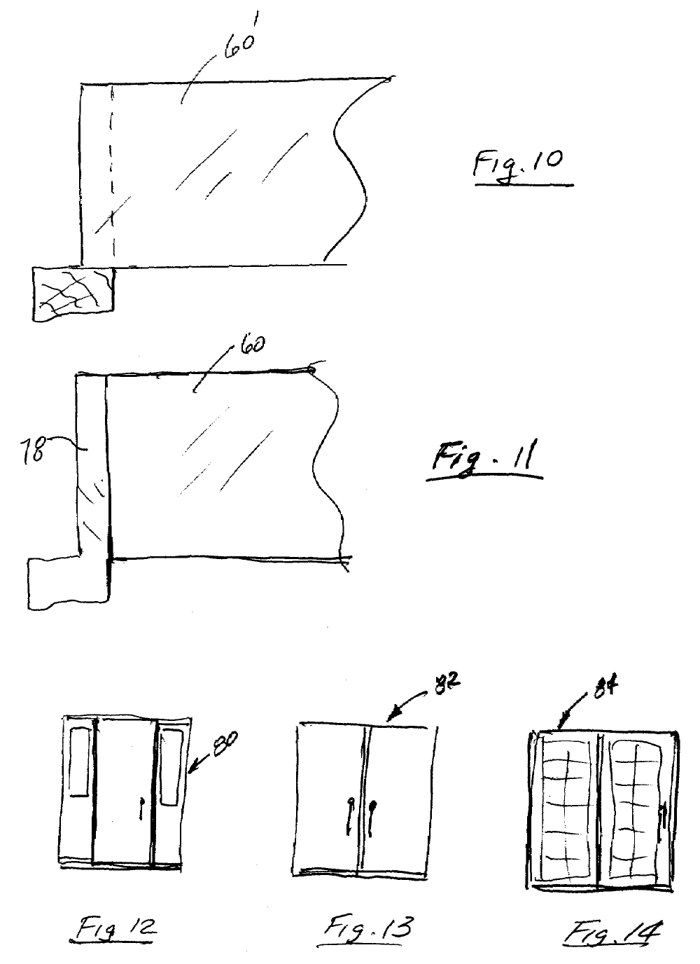

The present invention can take the form of a pre-hung exterior door assembly or alternatively, the invention can be utilized with a sill assembly which is used to construct a door frame at the job site. When part of a pre-hung exterior door assembly, ideally the elongate elastomeric seal member will not only span the entire length of the sill, but, will also extend over the ends of the vertical jambs. FIG. 10 illustrates a bottom view of a pre-hung exterior door assembly with elastomeric seal member 60″ extending over the sill and the jamb end. In FIG. 11, an alternate structure is illustrated. Elastomeric seal 60 only extends the length of the sill. The ends of the jambs as well as the ends of the brick mold is covered by a jamb end seal member 78, having a similar thickness and physical properties as the elongate elastomeric seal 60 which underlies the sill.

While the sills illustrated in FIGS. 1-6 are for a single entryway door, it should be appreciated that this invention can be utilized with a variety of door designs and it is not limited to a single pre-hung entryway door. FIG. 12 illustrates a pre-hung entryway door 80 having a pair of side lights, a single sill extends beneath the door as well as the adjacent side lights. In a pre-hung entryway door of this design, the elongate elastomeric seal member would span the entire sill length.

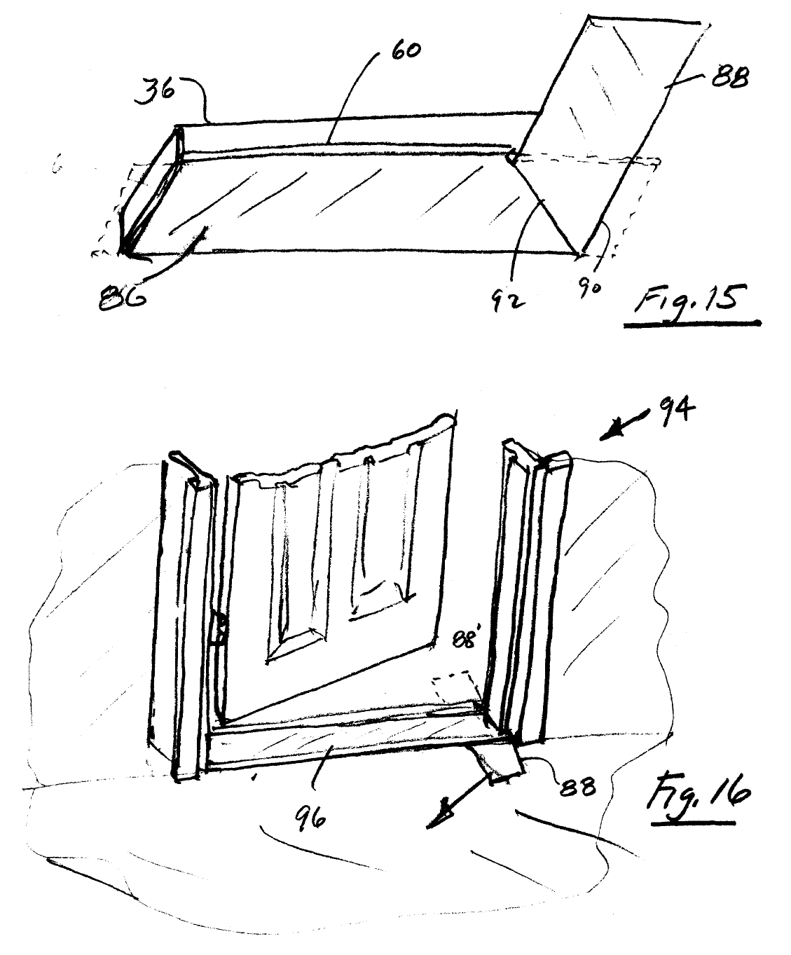

FIG. 13 illustrates a pre-hung entryway double door 82. The sill extends under both the passive and active doors between the two vertical jamb members. Similarly, the elongate elastomeric seal will extend the entire sill length. FIG. 14 illustrates yet another door embodiment, namely, a patio door 84 having a fixed panel and an active panel with an elongate sill underlying both panels. The elongate elastomeric seal member would span the entire sill length for a pre-hung exterior door assembly of any of the doors illustrated in FIGS. 1 and FIGS. 12-14.

FIG. 15 illustrates a sill block 36 provided with an alternative release film structure 86. Sill block 36 is provided with an elastomeric seal 60 as previously described. The release film 86 extends the length of the sill as previously described, however, in this embodiment, the release film extends significantly beyond one end of the sill to provide an end region 88 which is intended to be grasped by the installer to facilitate removal of the release film. End region 88 extends in a fore and aft direction so that the end region is accessible when the sill or pre-hung entryway door is installed as shown in FIG. 16. End region 88 may extend outwardly or inwardly as shown by alternative end unit orientation 88′ illustrated in phantom outline. The end region 88 of the release film projects outwardly in either the fore or aft direction by simply making two folds 90 and 92 in the release film. It should be appreciated that this release film embodiment can be utilized with a prefabricated sill assembly as well as a prefabricated entryway door assembly. When used with a prefabricated entryway door assembly, the release film will preferably extend over the jamb ends as illustrated in FIG. 10 and as illustrated in phantom outline in FIG. 16.

When release film 86 is provided with an outwardly extending end region 88, the entryway door 94 can be installed in the rough building opening with the release film still in place atop elastomeric seal 60. The release film end region 88 will extend outward or inward relative to sill 96 so that the end may be grasped by the installer. After the door is properly fit up, the installer may grasp the end region 88 of the release film and pull the release film out before completing the final assembly. Enabling the installer to remove the release film after the door is fit up and working properly, eliminates the problem associated with getting the elastomeric seal 60 dirty during installation or having to remove the entryway door after the elastomeric seal with the release film removed has been installed in order to make an adjustment to the rough building opening size.

Similarly, elongate sill assemblies utilizing the present invention can be provided separate from a pre-hung door assembly. These sill assemblies will have an elongate elastomeric seal member underlying the sill and extending the entire sill length in order to provide a weather tight seal between the sill and the bottom plate defining the rough building opening into which it is installed.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A pre-hung exterior door assembly for installation within a rough opening in a building, the opening having a top, a pair of spaced apart generally vertical sides and a generally flat bottom plate, the pre-hung exterior door assembly comprising:
a frame, formed by a pair of spaced apart elongate vertical jamb members and a top jamb spanning between and interconnecting the vertical jamb member upper ends;
a sill assembly horizontally spanning between and interconnecting the vertical jamb member lower ends, the sill assembly having a generally horizontal upper threshold portion and a generally horizontal lower surface, the sill and frame defining a doorway opening;
an entryway door mounted within the doorway opening and movable between an open position to allow egress to the building and a closed position in which a peripheral region of the door engages the frame and the sill threshold forming a weather tight seal;
an elongate elastomeric seal member which extends the length of the sill having an upper surface bonded to the sill lower surface and self-adhesive bottom surface for attachment to the rough opening bottom plate; and
a removable release film layer attached to the elongate elastomeric seal member bottom surface to facilitate shipping, handling and initial fit up of the door assembly, the removable release film being removable by an installer at the time of final installation of the door to achieve a weather-tight seal between the sill and the building opening bottom plate.

2. The pre-hung exterior door assembly of claim 1 wherein the elastomeric seal member further comprises a sheet of self-adhesive material having a thickness of about 0.050 to 0.250 inches, a continuous length sufficient to span between vertical door jambs and a width greater than about 1.0 inch.

3. The pre-hung exterior door assembly of claim 2 wherein the elastomeric seal member has a width greater than about 2 inches.

4. The pre-hung exterior door assembly of claim 2 wherein the elastomeric seal member has a length sufficient to overlap the ends of the vertical jamb members.

5. The pre-hung exterior door assembly of claim 1 wherein the elastomeric seal member is provided by a layer of sheet material comprising a butyl rubber compound.

6. The pre-hung exterior door assembly of claim 1 wherein the elastomeric seal member is a two-sided self-adhesive foam tape.

7. The pre-hung exterior door assembly of claim 1 wherein the elastomeric seal member is a polymer gel.

8. The pre-hung exterior door assembly of claim 1 wherein the sill assembly further comprises a metal seal upper member and a rot resistant sill based block attached to an underside region of the sill upper member providing a sill lower surface to which the elastomeric seal member is bonded.

9. The pre-hung exterior door assembly of claim 8 wherein the sill lower surface is substantially planar and the removable release film layer has an end region that extends sufficiently beyond the sill base block in a fore and aft direction to be grasped by the installer and removed after the door has been installed in the rough door opening and the sill is sitting atop the building opening bottom plate.

10. The pre-hung exterior door assembly of claim 8 wherein the sill lower surface has a planar surface region with at least one shallow elongate channel formed therein sized to receive the elastomeric seal member therein.

11. A sill assembly for use with an exterior door assembly having a door frame installed within a rough opening in a building, the sill assembly spanning between spaced apart door frame vertical jamb members and lying atop a generally flat bottom plate forming a lower portion of the building opening, the sill assembly comprising:
a sill upper member;
a sill base block oriented beneath the sill upper member;
a threshold mounted atop the region of the sill upper member below a door mounted within the door frame;
a sill base block oriented beneath the sill upper member,
an elongate elastomeric seal member which extends the length of the sill having an upper surface bonded to the sill base block lower surface and self-adhesive bottom surface for attachment to the rough opening bottom plate; and
a removable release film layer attached to the elongate elastomeric seal bottom surface to facilitate shipping, handling and initial fit up of the door assembly, the removable release film being removable by an installer at the time of final installation of the door to achieve a weather-tight seal between the sill and the building opening bottom plate.

12. The sill assembly of claim 11 wherein the elastomeric seal member further comprises a sheet of self-adhesive material having a thickness of about 0.050 to 0.250 inches, a continuous length sufficient to span between vertical door jambs and a width greater than about 1.0 inch.

13. The sill assembly of claim 11 wherein the elastomeric seal member has a length sufficient to overlap the ends of the vertical jamb members.

14. The sill assembly of claim 11 wherein the elastomeric seal member is a two-sided self-adhesive foam tape.

15. The sill assembly of claim 11 wherein the elastomeric seal member is a polymer gel.

16. The sill assembly of claim 11 wherein the sill assembly further comprises a metal sill upper member and a rot resistant sill based block attached to an underside region of the sill upper member providing a sill lower surface to which the elastomeric seal member is bonded.

17. The sill assembly of claim 16 wherein the sill lower surface is substantially planar.

18. The sill assembly of claim 16 wherein the sill lower surface has a planar surface region with at least one shallow elongate channel formed therein sized to receive the elastomeric seal member therein.

19. The sill assembly of claim 11 wherein the removable release film layer has an end region that extends sufficiently beyond the sill base block in a fore and aft direction to be grasped by the installer and removed after the sill has been installed in the rough door opening and is sitting atop the building opening bottom plate.

20. A pre-hung exterior door assembly for installation within a rough opening in a building, the opening having a top, a pair of spaced apart generally vertical sides and a generally flat bottom plate, the pre-hung exterior door assembly comprising:
a frame, formed by a pair of spaced apart elongate vertical jamb members and a top jamb spanning between and interconnecting the vertical jamb member upper ends;
a sill assembly horizontally spanning between and interconnecting the vertical jamb member lower ends, the sill assembly having a sill upper member, a threshold mounted atop the region of the sill upper member below a door mounted within the door frame, and a sill base block oriented beneath the sill upper member with a generally planar horizontal lower surface, the sill and frame defining a doorway opening;
an entryway door mounted within the doorway opening and movable between an open position to allow egress to the building and a closed position in which a peripheral region of the door engages the frame and the sill threshold forming a weather tight seal;
an elongate elastomeric seal member forming a sheet having a thickness of about 0.050 to 0.250 inches, a width greater than about 1.0 inch and a length of at least about the length of the sill, having an upper surface bonded to the sill lower surface and a self-adhesive bottom surface for attachment to the rough opening bottom plate; and
a removable release film layer attached to the elongate elastomeric seal member bottom surface to facilitate shipping, handling and initial fit up of the door assembly, the removable release film being removable by an installer at the time of final installation of the door to achieve a weather-tight seal between the sill and the building opening bottom plate.
